(19) United States
(12) Patent Application Publication
(10) Pub. No.: US 2007/0076750 A1
(43) Pub. Date: Apr. 5, 2007

(54) Device driver interface architecture

(75) Inventors: Robert A. Kleewin, Redmond, WA (US); David R. Fulmer, Redmond, WA (US); Michelle V. Niethammer, Redmond, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/241,174

(22) Filed: Sep. 30, 2005

(51) Int. Cl. H04J 3/16

(52) U.S. Cl. 370/466

(57) ABSTRACT

An IR device driver architecture is disclosed that may enable one or more different types of wireless transceiver devices to communicate with a media application. The IR device driver architecture also discloses one or more application program interfaces that may be exposed to enable the different types of wireless transceiver devices to interact with the media application.

### PRIORITY CLAIM

This application claims the benefit of U.S. Provisional Patent Application No. 60/881,618, filed on May 6, 2005, which is incorporated by reference herein.

### TECHNICAL FIELD

The technology relates generally to software and hardware interaction and, more particularly, to one or more communication interfaces that may enable different types of wireless transceiver devices with a variety of hardware architectures to communicate with computing devices.

### BACKGROUND

Computers may communicate with other systems and devices using wireless signals, such as infrared light, for transferring data in substantially the same manner that a television remote control unit sends signals representing commands issued to a television or set-top box, for example. In fact, some newer computers come with built-in infrared transceivers for engaging in such wireless communications. Some software operating systems, such as Windows® XP®, may even enable their hosting computer systems to use these infrared transceivers for communicating with other wireless enabled devices, such as television or set-top boxes and/or their corresponding remote control devices, printers, modems, digital pagers, personal digital assistants, electronic cameras, organizers, cellular phones, and hand-held computers, for instance.

### SUMMARY

The following section of this patent application document presents a simplified summary of the disclosed subject matter in a straightforward manner for readability purposes only. In particular, this section attempts expressing at least some of the general principles and concepts relating to the disclosed subject matter at a relatively high-level simply to impart a basic understanding upon the reader. Further, this summary does not provide an exhaustive or limiting overview nor identify key and/or critical elements of the disclosed subject matter. As such, this section does not delineate the scope of the ensuing claimed subject matter and therefore the scope should not be limited in any way by this summary.

Basically, an exemplary IR device driver architecture is disclosed that may enable one or more different types of wireless transceiver devices to communicate with a media application via an IR transceiver device, for example. Further, the IR device driver architecture may enable the media devices to be controlled using a single IR remote control device, for example, although a number of remote control device could be used.

### BRIEF DESCRIPTION OF THE DRAWINGS

The ensuing detailed description section will be more readily appreciated and understood when read in conjunction with the accompanying drawings, wherein:

FIG. 1 is a diagram of a suitable environment in which one or more examples of device driver interfaces may be implemented;

FIG. 2 is a diagram of computer that may be used in the example of the suitable environment illustrated in FIG. 1;

FIG. 3 is a diagram of a device driver stack that may be employed in an IR device driver interface architecture that may be used in the example of the suitable environment illustrated in FIG. 1;

FIG. 4 is a diagram of an IR device driver interface architecture that may be used in the example of the suitable environment illustrated in FIG. 1;

FIG. 5 is a diagram of a payload code determination module that may be employed in the IR device driver interface architecture shown in FIG. 4;

FIG. 6 is a diagram of a payload data extraction module that may be employed in the IR device driver interface architecture shown in FIG. 4;

FIG. 7 is a diagram of an exemplary portion of a infrared waveform; and

FIG. 8 is a flow chart of a process for operating the IR device driver interface architecture shown in FIG. 4.

The same reference numerals and/or other reference designations employed throughout the accompanying drawings are used to identify identical components except as may be provided otherwise.

### DETAILED DESCRIPTION

The accompanying drawings and this detailed description provide exemplary implementations relating to the disclosed subject matter for ease of description and exemplary purposes only, and therefore do not represent the only forms for constructing and/or utilizing one or more components of the disclosed subject matter. Further, while this description sets forth one or more exemplary operations that may be implemented as one or more sequence(s) of steps expressed in one or more flowcharts, the same or equivalent operations and/or sequences of operations may be implemented in other ways.

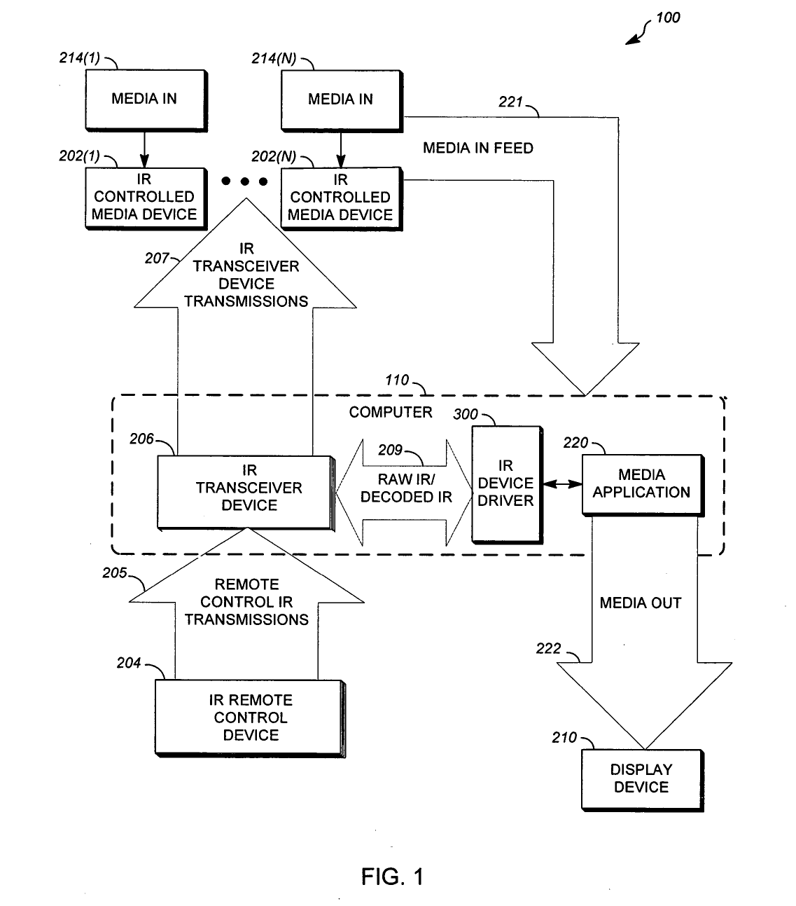

FIGS. 1, 4 and 8 generally show examples of an IR device driver 300 and a method 400 for operating the driver 300, which may be implemented using a computer 110, for example. Basically, the exemplary IR device driver 300 may enable one or more different types of IR controlled media devices 202(1)-202(N) to communicate with media application 220 via IR transceiver device 206, although other types of communication media besides IR may be used. Moreover, IR device driver 300 may enable the media devices 202(1)-202(N) to be controlled using the same IR remote control device 204, for example. By way of example only, this arrangement may enable users to interact with media application 220 for consuming media 214(1)-214(N) originating from one or more corresponding IR controlled media devices 202(1)-202(N).

Media device control units, such as remote control units, may be used to send device control related input entered by users to corresponding media devices, although some control units may also receive feedback or other information from the media devices. Media device control units may typically use infrared (“IR”) communication signals to send the device control related input to the media devices, although other wireless or wire-based communication signals could be used. When device control related input are sent via IR communication signals, for instance, various media device related functions, such as power on/off, play, volume up/down, and the like, may be assigned particular function codes that may be modulated with an IR carrier frequency.

Different types and/or brands of media devices may often implement their own unique function codes as a set of unique function codes for representing the different functions that their corresponding media device control units can send them as device control related input, although sometimes some of the function codes from different sets may overlap. An original equipment manufacture (“OEM”) media device control unit may often just store the function code set for its corresponding media device. Moreover, individual OEM media device control units typically will be used to control each of the different types and/or brands of media devices.

At least one approach that may be taken for providing users with control over a number of different types and/or brands of media devices may involve storing a number of different media device function code sets in a media device control unit's memory for each of the corresponding different types and/or brands of media devices, for example. Another approach may involve enabling the media device control units to learn and/or otherwise obtain different types and/or brands of media device function code sets from the corresponding media device control units themselves or elsewhere, for instance.

One or more other approaches that may be taken for providing users with control over a number of different types and/or brands of media devices may involve implementing a number of programmatic infrastructures that may enable devices to extract and/or decode different media device function code sets encoded in the communication signals. In particular, the disclosed programmatic infrastructures may enable recognizing a number of properties describing raw, unprocessed communication signals, such as raw IR waveforms. These recognized properties may be used to identify which media device function code sets may have been encoded in the communication signal. In this way, devices may encode and/or decode control command input to/from code functions expressed in the communication signals.

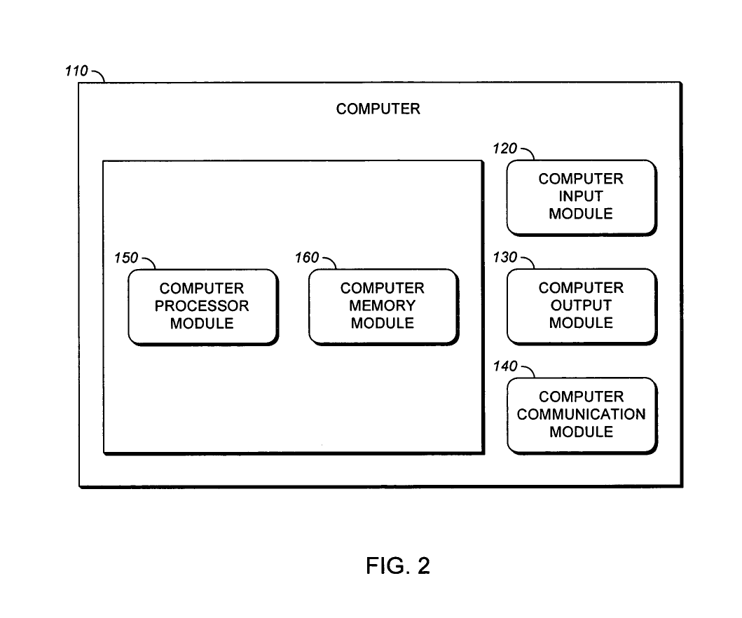

Referring generally now to FIGS. 1 and 2, an operating environment 100 is illustrated to provide an example of a suitable arrangement in which an IR device driver 300 may be implemented using a computer 110, for example. The environment 100 represents just one example of a number of other possible environments that may be suitable, and therefore is not intended to suggest any limitation as to the scope of use or functionality of the exemplary IR device driver 300. Further, the exemplary IR device driver 300 should not be interpreted as having any dependency or requirement relating to any one or more of the components illustrated in FIGS. 1 and 2, or any other figures, unless expressly stated otherwise.

Generally, IR device driver 300 may be operational with numerous other general purpose or special purpose computing system environments or configurations. Examples of other computing systems, environments, and/or configurations that may be suitable for use with the IR device driver 300 may include, but may not be limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices and the like, including any other conventional or later developed technologies.

The IR device driver 300 is described herein in the general context of computer-executable instructions, such as one or more program modules, which may be executed by one or more processing systems, such as computer processor module 150 in computer 110 shown in FIG. 2, although other types of processing systems may be used. Generally, program modules may include routines, programs, objects, components, data structures, etc., which may perform particular tasks or implement particular abstract data types. The IR device driver 300 may also be practiced in distributed computing environments where tasks may be performed by remote processing devices that may be linked through a communications network. In a distributed computing environment, program modules may be located in both local and remote computer storage media, including memory storage devices, such as computer memory module 160, for example.

Referring now specifically to FIG. 2, computer 110 in its most basic configuration may represent a general purpose computing device, although a number of other devices could be used. In its most basic configuration, computer 110 may comprise computer input module 120, computer output module 130, communication module 140, computer processor module 150, and computer memory module 160, which may be coupled together by one or more bus systems or other communication links, although computer 110 may comprise other elements in other arrangements. Modules 120, 130, 140, 150 and 160 will now be described below with continued reference to FIG. 2.

Computer input module 120 may comprise one or more user input devices, such as a keyboard and/or mouse, and any supporting hardware, although other devices may be used. Computer input module 120 may enable a user who is operating computer 110 to generate and transmit signals or commands to computer processor module 150, such as commands for controlling one or more IR controlled media devices 202(1)-202(N), for example, although other types of user input devices may be used.

Computer output module 130 may comprise one or more mechanisms for enabling the results obtained from computer processor module 150 executing the one or more instructions stored in computer memory module 160 to be presented as output to one or more users via display device 210 (e.g., CRT, LCD or plasma display) shown in FIG. 1, for example.

Computer communication module 140 may comprise one or more communication interface devices, such as a network interface card (e.g., Ethernet card or wireless network card), and any supporting hardware, although other types of communication interface devices may be used, such as a serial interface (e.g., RS-232 interface). Computer communication module 140 may also include functionality that may enable the computer 110 to transmit and receive IR signals, which is depicted in FIG. 1 as IR transceiver device 206, for example. Generally, however, computer communication module 140 may enable computer 110 to transmit and/or receive data to and/or from other devices, such as other computing systems or peripherals (e.g., external memory storage device or printer), via a network or direct cable connection (e.g., USB, Firewire) or any other wireless communication media, for example.

Computer processor module 150 may access and/or may execute data and instructions stored in computer memory module 160 for controlling, monitoring and managing (hereinafter referred to as “operating”) computer input module 120, computer output module 130, Computer communication module 140 and computer memory module 160 as described herein, although some or all of the data and instructions may be stored in and/or executed by the modules themselves.

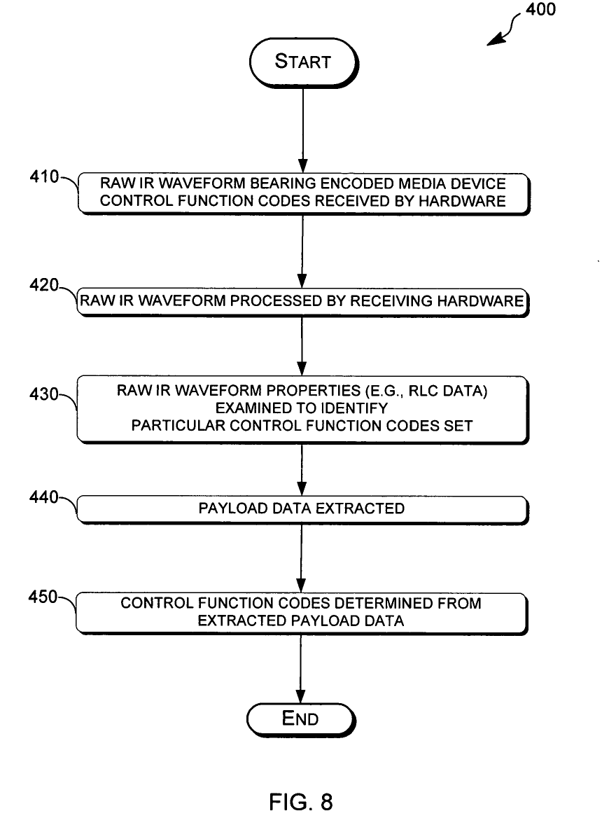

Additionally, computer processor module 150 may access and/or may execute data and instructions stored in computer memory module 160 to perform functions for implementing at least a portion of the method 400 as described herein in connection with FIG. 8, although computer processor module 150 may perform other functions, one or more other processing devices or systems may perform some or all of these functions, and computer processor module 150 may comprise circuitry configured to perform the functions described herein.

Computer memory module 160 may comprise one or more types of fixed and/or portable memory accessible by computer processor module 150, such as ROM, RAM, SRAM, DRAM, DDRAM, hard and floppy-disks, CDs, DVDs, magnetic tape, optical disk, ferroelectric and ferromagnetic memory, electrically erasable programmable read only memory, flash memory, charge coupled devices, smart cards, or any other type of computer-readable media, which may be read from and/or written to by one or more magnetic, optical, or other appropriate reading and/or writing systems coupled to computer processor module 150 and/or one or more other processing devices or systems.

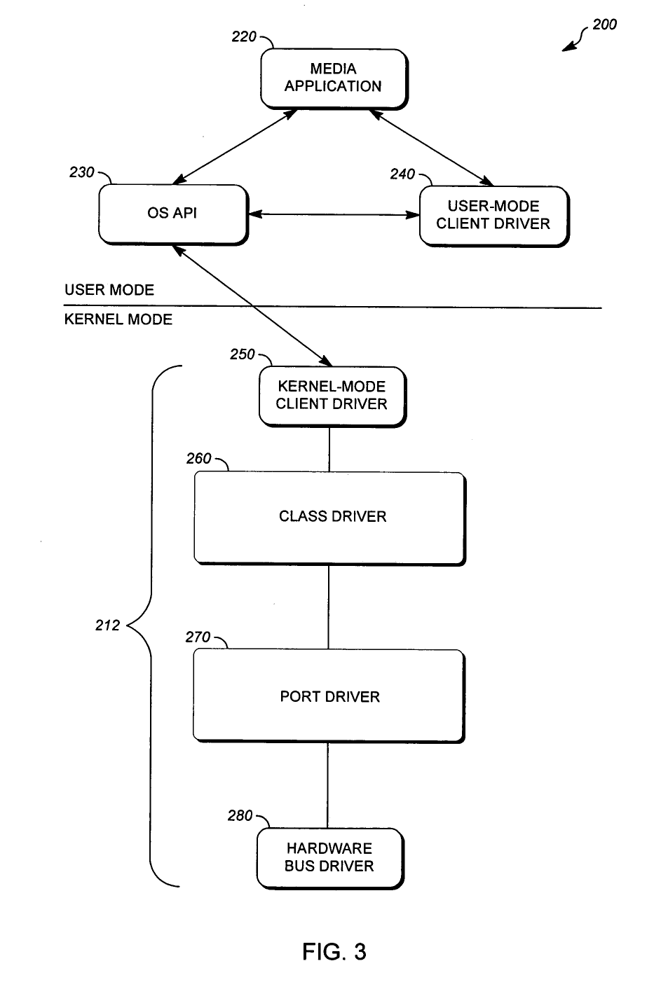

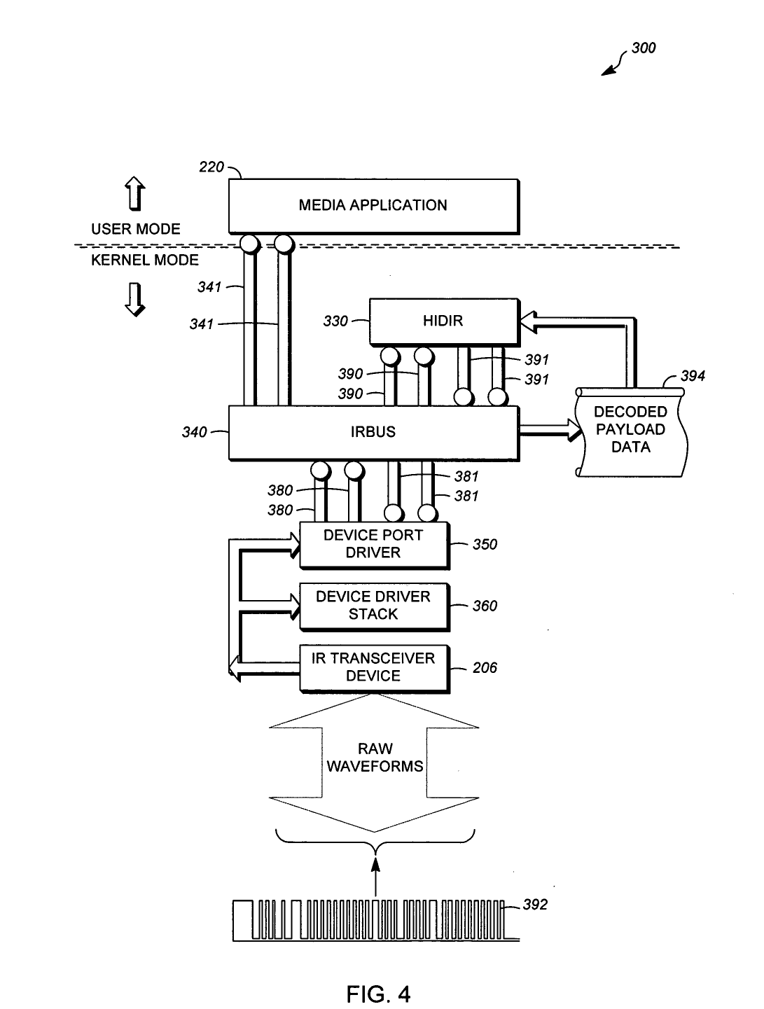

Further, computer memory module 160 may store at least a portion of the data and instructions that may be accessed and/or executed by computer processor module 150 for operating computer input module 120, computer output module 130, computer communication module 140, computer processor module 150 and computer memory module 160, although some or all of the data and instructions may be stored elsewhere, such as in the modules themselves and/or the computer processor module 150. Further, computer memory module 160 may store one or more modules representing instructions that may be executed by computer processor module 150 to implement one or more exemplary device drivers 200, 300 shown in FIGS. 3-4, respectively, and/or the method 400 shown in FIG. 8, for example.

With reference back to FIG. 1, other components that may be employed in the exemplary operating environment 100 to illustrate the utility of the IR device driver 300 may include one or more IR controlled media devices 202(1)-202(N), IR remote control device 204, IR transceiver device 206 and display device 210. By way of example only, IR controlled media devices 202(1)-202(N) may represent one or more electronic devices that may receive and process wireless (e.g., IR) signals from a number of devices, such as an IR transceiver device 206 in computer 110, although devices 202(1)-202(N) could receive and process other types of wireless and/or wire-based signals.

For instance, the IR transceiver device transmissions 207 shown in FIG. 1 may represent other types of signals transmitted to the devices 202(1)-202(N) besides IR using other communication transfer media, such as an RS-232 serial cable, Firewire cable, and other communication media. As will be described in greater detail further herein, regardless of the particular communication media coupling the computer 110 to the media devices 202(1)-202(N), the computer 110 may send the appropriate codes as determined from performing method 400, for instance, to the media devices 202(1)-202(N).

IR controlled media devices 202(1)-202(N) may receive media in 214(1)-214(N), respectively, such as cable signals. IR controlled media devices 202(1)-202(N) may provide the media in 214(1)-214(N) to computer 110. Computer 110, in turn, may provide media out 222, such as an audio/video output or an S-video output, to display device 210. IR controlled media devices 202(1)-202(N) may receive a cable signal via input 214, but instead of providing the cable output to a television, for example, media devices 202(1)-202(N) may provide the cable output as a media in feed 221 to computer 110. Computer 110, in turn, may provide an output as media out 222 (such as an audio/video output or an S-video output) to display device 210, such as a television, for example.

IR remote control device 204 may comprise a device that may control one or more of the IR controlled media devices 202(1)-202(N) via IR transceiver 206, for example, by emitting infrared (“IR”) radiation with data or control codes encoded therein, although the device 204 may directly control the controlled media devices 202(1)-202(N) as well. The emitted IR radiation may be detected by an IR transceiver device 206 in computer 110, although the emitted IR may be detected by an IR receiving device on IR controlled media devices 202(1)-202(N), for instance.

IR transceiver device 206 may comprise one or more mechanisms that may enable devices, such as the computer 110, to receive and/or transmit IR signals bearing encoded data (e.g., media device command codes), although IR device may comprise other types of devices that may enable computer 110 to receive and/or transmit other types of wireless and/or wire-based signals besides IR signals. IR transceiver device 206 may be coupled to computer 110 by any number of ways, such as by a universal serial bus (“USB”) cable, although device 206 may be coupled to computer 110 in other ways, such as directly to the computer's circuitry (e.g., computer motherboard).

The device 206's functionalities relating to receiving and/or transmitting may depend upon the particular environment where the device may be employed. For instance, if computer 110 is coupled to media devices 202(1)-202(N) via wire-based communication media (e.g., Firewire) and may send control signals over that media instead of using IR signals, then the device 206 may include IR receiving functionalities for receiving IR transmissions from IR remote control device 204.

In either case, where transceiver device 206 may receive IR signals, the device 206 may convert received analog infrared (“IR”) signals into an analog electrical signal, which may be passed to IR device driver 300 and/or other components of computer 110, although the device 206 may convert analog signals received in other formats over other communication media (e.g., RS-232 cables, Firewire) into an analog format suitable for passing along to the IR device driver 300 and/or other components of computer 110.

Where transceiver device 206 may transmit IR signals, the device 206 may comprise one or more other mechanisms that may convert digital signals from computer 110 into analog electrical signals suitable for conversion into corresponding IR signals, although the signals may be converted in other formats suitable for the appropriate communication media (e.g., RS-232 cables, Firewire). IR transceiver device 206 may emit IR signals matching the analog electrical signals for transmission to IR controlled media devices 202(1)-202(N), for example.

Referring generally to FIGS. 3-4, computer memory module 160 may also store one or more modules representing exemplary device drivers 200, 300, although one or more of the modules may be stored elsewhere. Again, the modules representing exemplary device drivers 200, 300 as shown in FIGS. 3-4, respectively, may comprise data and/or instructions written in a number of programming languages, which when accessed and/or executed by computer processor 150, may cause computer 110 to implement at least a portion of the method 400 as described herein and illustrated in FIG. 8, although the modules may comprise circuitry configured to operate in the manner described herein.

For ease of description and exemplary purposes only, the modules representing exemplary device drivers 200, 300 are shown in FIGS. 3-4, respectively, as a number of separate modules. It should be appreciated, however, that a fewer or greater number and other types of modules may be used. Moreover, one or more of the modules may reside on one or more other computing systems or devices, and the functionality of one or more of the modules may be combined and/or separated. Device drivers 200, 300 shown in FIGS. 3-4, respectively, will now be described in further detail herein below.

Referring now to FIG. 3, an exemplary driver 200 that may be implemented for enabling computer 110 to communicate with various devices, such as IR controlled media devices 202(1)-202(N), is shown. A media application 220 may logically reside a layer above the driver stack 212 shown in FIG. 3, which may handle requests from users and other applications. For instance, the media application 220 may be configured to enable users to control the one or more IR controlled media devices 202(1)-202(N) using the computer's input module 120 (e.g., keyboard), to control the devices 202(1)-202(N) via an automatic process (e.g., timed recording), and/or to control the devices 202(1)-202(N) from a remote location apart from the computer 110.

Further, application 220 may call either the OS API 230 or a routine that may be exposed by the user-mode client driver 240. A user-mode client driver 240 may handle requests from applications or from the OS API. For requests that may involve kernel-mode services, the user-mode client driver 240 may call the OS API 240, which may call the appropriate kernel-mode client or support routine to carry out the request. User-mode client drivers 240 may be implemented as dynamic-link libraries (DLL). For instance, printers support many operations that may be performed in user mode, and so may typically have user-mode clients. Disks and other storage devices, networks, and/or input devices, on the other hand, may not have user-mode clients.

A kernel-mode client driver 250 may handle requests similar to those handled by the user-mode client 240, except that these requests may be carried out in kernel mode rather than in user mode. A class driver 260 may provide device-specific support, system-support, hardware-independent support for a particular class of device and/or operations for a specific type of device of a particular class. A port driver 270 may interpret low level communication signals (e.g., IR signals) received via a hardware bus driver 280 into a suitable format that may be understood and processed by one or other components in computer 110. Hardware bus driver 280 may support I/O operations on an underlying port, hub, or other physical device through which the device attaches.

Referring now to FIG. 4, a more detailed example of an exemplary IR device driver 300 discussed above with respect to FIG. 3 that may be implemented in the IR device driver 300 to enable computer 110 to communicate with other devices using IR, for example, is shown. However, the exemplary IR device driver 300 may be implemented to enable computer 110 to communicate with other devices using other wireless and/or wire-based communication signals.

Generally, IR transceiver device 206 may comprise the hardware portion of a transceiver interface that may send and receive IR waveforms to and from other devices as mentioned above earlier, although the hardware 370 may comprise the hardware portion of any number of other types of interfaces. Further, the IR transceiver device 206 may be coupled to computer 110 via a USB connection, for example, although the hardware may be coupled to computer 110 by any number of other connection types, including serial port connections, parallel port connections, and/or Firewire connections.

Device driver stack 360 may communicate with the IR transceiver device 206 to make a raw waveform 392 received by hardware 370 available to the device port driver 350.

Device port driver 350 may comprise one or more mechanisms that may make determined RLC data available to the IRBUS 340 via the interfaces 380 and/or 381. In particular, such determined RLC data may be exposed or may otherwise be made available via one or more exposed methods, properties, events or attributes, for instance. Device driver interfaces 380 may conform to a particular protocol or standard, although no particular protocols or standards need be used. Likewise, IRBUS 340 may expose one or more interfaces 381 to device port driver 350 that may enable driver 350 to communicate with IRBUS 340 for various reasons, such as for sending messages to indicate that IR transceiver device 206 has received an IR waveform, for example. The interfaces 381 may comply with any such protocols or standards complied with by the device driver interfaces 380, although the interfaces 381 need not comply with any such protocols.

However, implementing device driver interfaces 380 and/or interfaces 381 that may conform to particular protocols or standards may enable IRBUS 340 to communicate with a number of different interfaces made by different manufacturers to ensure greater compatibility. Although not shown in FIG. 4, the device driver stack 360 may expose one or more interfaces that may enable the device port driver 350 to communicate with the stack 360, such as for sending one or more messages sent by IRBUS 340 via interfaces 380 to the stack 360.

Moreover, IR transceiver device 206 may also expose one or more interfaces (not illustrated) to the device driver stack 360 for enabling the stack 360 to communicate with the IR transceiver device 206 in this example, such as for forwarding any messages sent from IRBUS 340 onto IR transceiver device 206 for transmission as an IR waveform, for example. It may be noted that any such forwarded messages may have been received by the device driver stack 360 via one or more interfaces it may expose to the device port driver 350 or exposed to the stack 360, which in turn may have received the messages from IRBUS 340 via interfaces 380 and/or 381, for example.

IRBUS 340 may comprise one or more mechanisms that may decode RLC data and determine payload data represented by the RLC data for a particular protocol. In particular, IRBUS 340 may determine which particular values the decoded payload obtained from a raw waveform 392 may represent based on the particular protocol the payload may conform to. For instance, IRBUS 340 may determine that decoded payload data 394 for the waveform represents a particular numeral in the RC-6 protocol.

IRBUS 340 may make the decoded payload 394 available to HIDIR 330 via one or more other exposed interfaces 390 and/or 391. Further, IRBUS 340 may also make un-decoded IR data available directly to media application 220 via one or more exposed IRBUS/media interfaces 341, for example. This may enable the media application 220 to record the un-decoded data for subsequent playback to perform a number of functions, such as for learning IR codes that can be played back, and/or may enable the application to compare the un-decoded data to a library comprising stored IR codes, for instance.

HIDIR 330 may comprise one or more modules that may determine what particular function codes the decoded payload data 394 may represent based on the particular protocol the payload data 394 may conform to. For instance, HIDIR 330 may determine that the decoded payload data 394 corresponding to a particular numeral in the RC-6 protocol may represent a particular command code describing one of the functions (e.g., on/off, change channel) to be performed by one or more IR controlled media devices 202(1)-202(N).

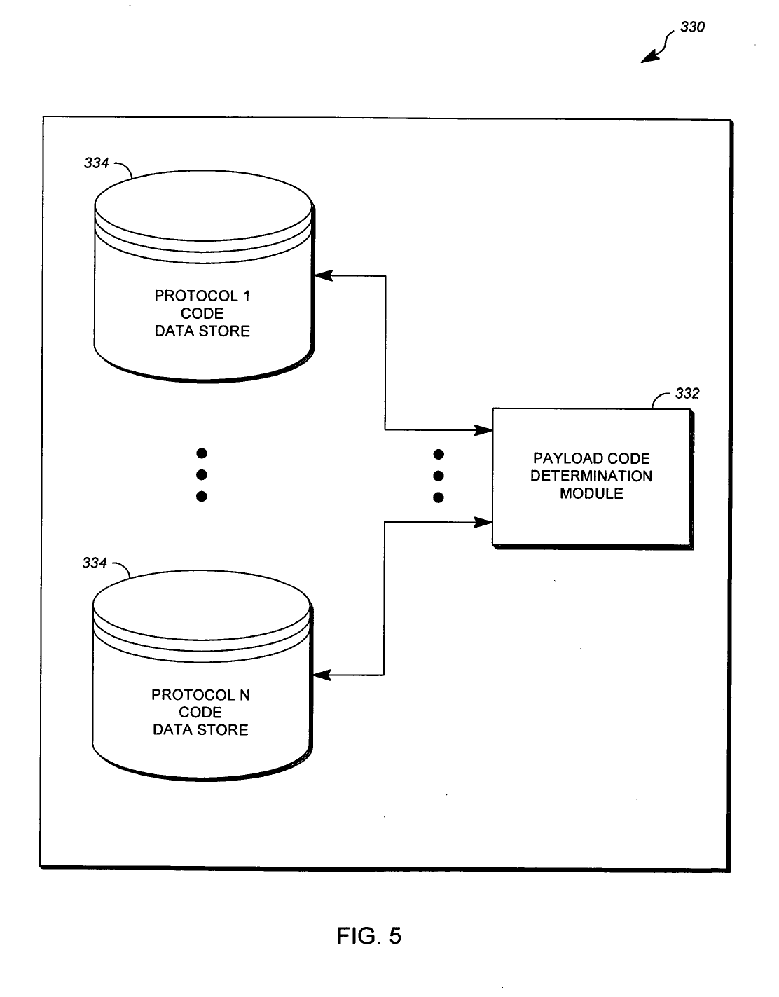

FIG. 5 is a block diagram showing exemplary modules that may be used to implement the functionality described herein with respect to IRBUS 340, although other components in other arrangements may be used. Basically, the payload data extraction module 342 in IRBUS 340 may identify the particular protocol that the determined RLC data may conform to. In particular, payload data extraction module 342 may search one or more component matching data stores 344 to identify one or more components of the determined RLC data that may correspond to one or more representative components for one or more particular protocols that may be stored in the data store 344. For instance, payload data extraction module 342 may select definitions of one or more representative components of a first protocol from the protocol component matching data store 344, such as a leader pulse definition, “0” and “1” normal bit definitions, “0” and “1” trailer bit definitions.

It is noted that the one or more representative components selected by payload data extraction module 342 for comparison with one or more corresponding components of the RLC data may be different for the different protocol component definitions that may be stored in the protocol component matching data store 344. For instance, the payload data extraction module 342 may select definitions of one or more representative components of a second protocol from the protocol component matching data store 344, such as a command followed by a repeat code transmitted every 110 ms if the second protocol represents the NEC protocol, for example.

If the definitions of two or more representative components for two or more different protocols in the protocol component matching data stores 344 match one or more corresponding components of the RLC data, the payload data extraction module 342 may decode the RLC data according to the one or more determined protocols to obtain the payload data 394 encoded therein. HDIR 330 may interpret the particular function codes corresponding to the decoded RLC data for the one or more determined protocols and decide which action to take based on the interpreted code, for instance.

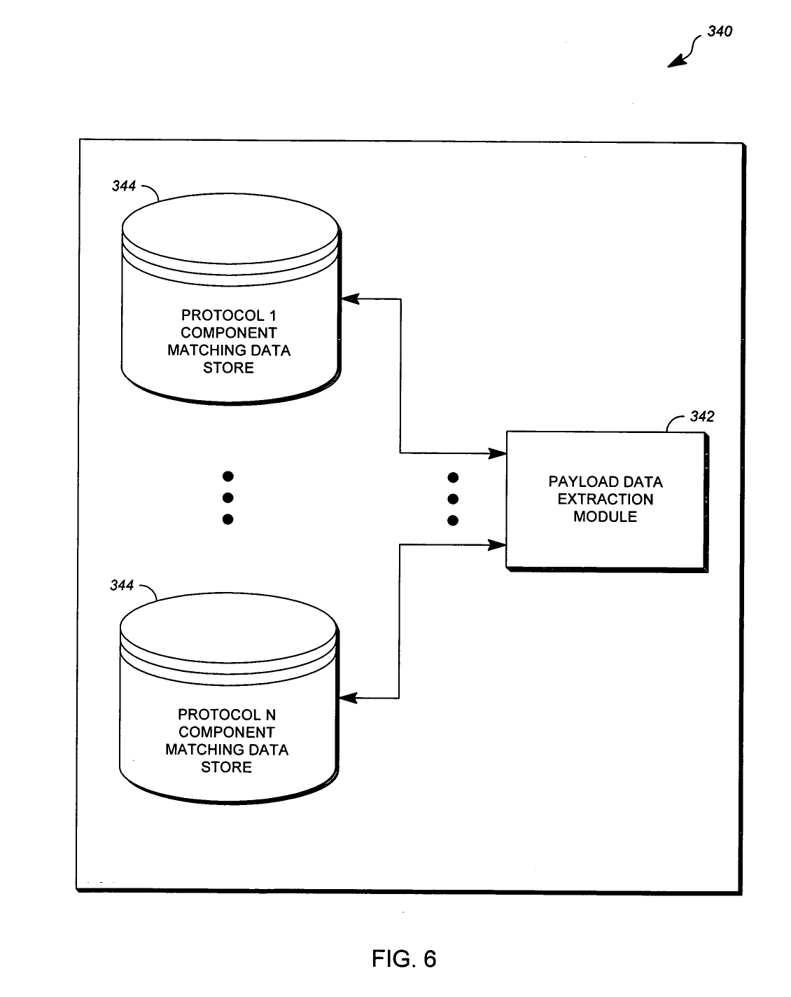

FIG. 6 is a block diagram showing exemplary modules that may be used to implement the functionality described herein with respect to HIDIR 330, although other components in other arrangements may be used. As mentioned above earlier, IRBUS 340 may make the decoded payload data 394 available to HIDIR 330 via one or more interfaces 380, 381. When HIDIR 330 obtains the decoded payload data 394, the payload code determination module 332 in HIDIR 330 may find a value in a protocol code definition data store 334 corresponding to the RLC data's protocol that may match the payload data 394 to obtain the code for the payload data 394. HIDIR 330 may then forward or make available the obtained code to the media application 210 via one or more interfaces that may be exposed to the application 310 by HIDIR 330, which may process the code accordingly.

As will be described in greater detail below in connection with method 400 illustrated in FIG. 8, when computer receives IR transmissions via IR transceiver device 206 from an IR remote control device 204 for controlling one or more IR controlled media devices 202(1)-202(N), IRBUS 340 may convert the IR waveform envelopes into run length code (“RLC”) data representations of the waveforms. RLC data may comprise a string of numbers representing the envelope of an IR waveform, such as “2656−888 444−444 . . . ”, for example.

In particular, the hardware in the IR transceiver device 206 may convert the received IR waveform signals into electrical signals that may be used by the device port driver 350 and device driver stack 360 for generating the low level RLC data as one or more bytes of data. The RLC data may be made available by the device port driver via one or more exposed port driver/IRBUS interfaces 380, for instance. Further, IRBUS 340 may decode the RLC data for a particular protocol that the IRBUS identifies the data as being in, and may access HIDIR 330 to determine the function code that may be represented by the RLC data, such as a channel change, a number of digits representing particular channels, spacing, repeat patterns and/or an enter key, for example.

On the other hand, when media application 220 operating in computer 110 desires using the IR transceiver device 206 to transmit command function codes as IR waveforms to one or more IR controlled media devices 202(1)-202(N) in the form of IR waveforms, for example, IRBUS 340 may access HIDIR 330 to identify the RLC data corresponding to the particular function codes. IR transceiver device 206 may generate and emit raw IR waveforms 392 representing RLC data identified by the IRBUS 340. In particular, IRBUS 340 may generate a stream of one or more bytes representing the identified RLC data in a particular protocol, such as RC-6, and may provide the bytes of data to the device port driver 350. The device port driver 350 may interpret the stream of bytes and provide information to the device driver stack 360 that may enable the transceiver device 206 to emit the IR signals representing the code desired to be transmitted by the computer 110, for instance.

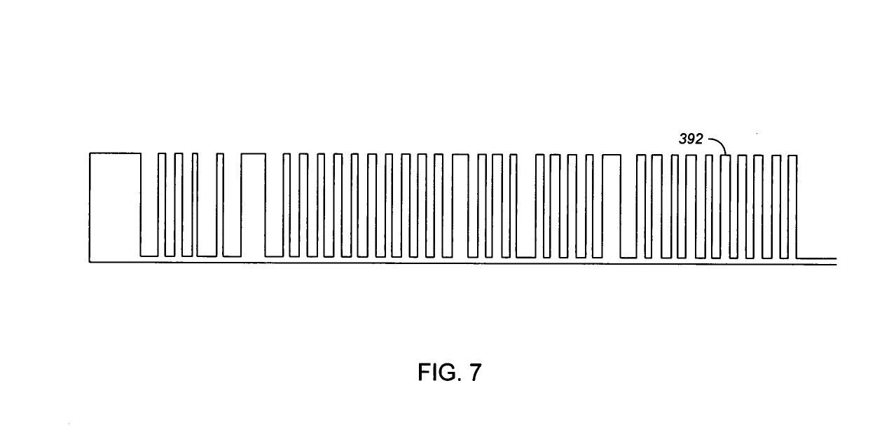

A method 400 shown in FIG. 8 will now be described with reference back to FIG. 4 in the context of being carried out in the environment 100 described above in connection with FIGS. 1-7. By way of example only, a user may desire using media devices 202(1)-202(N) for a variety of reasons. Further, the user may desire controlling media devices 202(1)-202(N) using a device, such as computer 110, rather than using multiple devices. The computer 110 may also provide additional functionality, such as audio or video recording functionality. By way of example only, a user can program computer 110 via media application 210, for instance, to record a television program when the user may not be present. This scenario may be now described to illustrate other portions of the present IR device driver 300, but the IR device driver 300 may be by no means limited by this description. It may be recognized that the IR device driver 300 may be equally applicable to any situation where it may be desired to enable a device to communicate with other devices.

Referring to FIG. 8 and beginning method 400 at step 410, raw IR waveforms 392, shown in FIG. 1 as remote control IR transmissions, may be transmitted to computer 110 by way of IR remote control device 204 and received by IR transceiver device 206, for instance. At step 420, IR transceiver device 206 may convert the envelope of the raw IR waveform into RLC data, which may be provided to the device driver stack 360 and hence IRBUS 340, for instance.

At step 430, IRBUS 340 may obtain the RLC data via one or more of the exposed interfaces 381, for instance. In particular, the RLC data forwarded to the device driver stack 360 by the IR transceiver device 206, which may represent a 32 bit number, for example, may in turn be forwarded to the device port driver 350. In turn, the device port driver 350 may make the determined RLC data available to the IRBUS 340 via the interfaces 381, for instance.

At step 440, the IRBUS 340 may decode the RLC data to extract the payload data represented by the RLC data for a particular protocol. IRBUS 340 may be configured to determine RLC data encoded in waveforms that may conform to a number of protocols, such as an RC-6 protocol. IRBUS 340 may determine that the decoded payload data for the RLC data corresponding to the raw waveform 392 may represent a particular numeral in the RC-6 protocol. In turn, IRBUS 340 may make the decoded payload available to HIDIR 330 via one or more exposed IRBUS/HIDIR interfaces 390, for instance.

At step 450, HIDIR 330 may then determine what value the decoded payload from the waveform represents for whichever particular protocol the payload may conform to. For instance, the decoded payload data may represent a command that may be interpreted by the media application 220, such as a command to begin displaying media out 222 using the display 210. For example, one or more other commands that may be extracted from raw waveforms 392 during implementation of steps 410-450 may instruct the media application to begin receiving media from one or more of the IR controlled media devices 202(1)-202(N) for presentation on the display device 210.

Furthermore, while particular examples and possible implementations have been called out above, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents. Further, the recited order of processing elements or sequences, or the use of numbers, letters, or other designations therefore, is not intended to limit the claimed process to any order except as may be specified in the claims.

What is claimed is:

1. A system comprising:
a first module having one or more hardware components for converting communication signals into a first communication protocol;
a second module that programmatically identifies one or more meanings of one or more code representations expressed by the communication signals in the first protocol; and
the second module converting the identified code meanings into a second protocol interpretable by one or more media components.

2. The system of claim 1 wherein the one or more hardware components comprise at least one of either an IR transmitter, an IR receiving device or any other communication transmitting or receiving device.

3. The system of claim 1 wherein the second module instructs the first module to send one or more interpreted communication signals to the one or more media components.

4. The system of claim 3 wherein the first module sends control instructions encoded in the one or more interpreted communication signals to the one or more media components via the hardware-based communication device.

5. The system of claim 3 wherein the second module instructs the first module via at least one application program interface exposed by the hardware-based communication device.

6. The system of claim 3 wherein the one or more media components comprise at least one of either a media receiving device, a media application software application, or any other media related component.

7. A system comprising:
a first module that programmatically identifies one or more meanings of one or more code representations desired to be transmitted as communication signals to one or more media related components;
a second module having one or more hardware components for converting the one or more meanings of the code representations into a communication signals in a first communication protocol;
the second module transmitting the communication signals in the first communication protocol to the one or more media related devices.

8. The system of claim 7 wherein the one or more hardware components comprise at least one of either an IR transmitter, an IR receiving device or any other communication transmitting or receiving device.

9. The system of claim 7 wherein the first module sends control instructions encoded in the one or more interpreted communication signals sent to the at least one other device via the hardware-based communication device.

10. The system of claim 7 wherein the first module instructs the hardware-based communication device via at least one application program interface exposed by the hardware-based communication device.

11. The system of claim 7 wherein the first module comprises one or more media application software applications.

12. The system of claim 7 wherein the first module compares one or more components in communication signals received by the hardware components in the second module against one or more known components from one or more known communication protocols to identify one or more particular protocols used to encode data in the communication signals.

13. The system of claim 12 wherein the first module extracts the encoded data from the communication signals in the one or more identified particular protocols and identifies one or more function command codes for one or more media related components using the extracted data.

14. At least one computer-readable medium having stored instructions which when executed by at least one processing systems, causes the at least one processing system to implement:
a first module that communicates with a hardware-based communication device; and
a second module that programmatically interprets communication signals from a first protocol interpretable by the hardware-based communication device to a second protocol interpretable by the first module.

15. The medium of claim 14 wherein the hardware-based communication device comprises at least one of either an IR transmitter, an IR receiving device or any other communication transmitting or receiving device.

16. The medium of claim 14 wherein the first module instructs the hardware-based communication device to send one or more interpreted communication signals to one or more media related components.

17. The medium of claim 14 wherein the first module sends control instructions encoded in the one or more interpreted communication signals sent to the at least one other device via the hardware-based communication device.

18. The medium of claim 14 wherein the first module instructs the hardware-based communication device via at least one application program interface exposed by the hardware-based communication device.

19. The medium of claim 14 wherein the first module communicates with the hardware-based communication device via:
at least one application program interface that exposes at least one of either one or more methods, properties, events or attributes relating to a communication between the first and second modules.

20. The medium of claim 14 wherein the first module comprises one or more media application software applications.
